(19) United States
(12) Patent Application Publication
(10) Pub. No.: US 2010/0287217 A1
(43) Pub. Date: Nov. 11, 2010

(54) HOST CONTROL OF BACKGROUND GARBAGE COLLECTION IN A DATA STORAGE DEVICE

(75) Inventors: Albert T. Borchers, Santa Cruz, CA (US); Andrew T. Swing, Los Gatos, CA (US); Robert S. Sprinkle, San Jose, CA (US)

Correspondence Address: BRAKE HUGHES BELLERMANN LLP;c/o CPA Global, PO Box 52050, Minneapolis, MN, 55402, US

(73) Assignee: GOOGLE INC., Mountain View, CA (US)

(21) Appl. No.: 12/755,968

(22) Filed: Apr. 7, 2010

Related U.S. Application Data
(60) Provisional application No. 61/167,709, filed on Apr. 8, 2009.
(60) Provisional application No. 61/187,835, filed on Jun. 17, 2009.
(60) Provisional application No. 61/304,469, filed on Feb. 14, 2010.
(60) Provisional application No. 61/304,468, filed on Feb. 14, 2010.
(60) Provisional application No. 61/304,475, filed on Feb. 14, 2010.

(51) Int. Cl. G06F 17/30; G06F 3/00; G06F 12/02

(52) U.S. Cl. 707/813; 710/18; 711/103; 707/E17.007; 711/E12.008

(57) ABSTRACT

An apparatus includes a flash memory data storage device and a host operably coupled to the data storage device via an interface. The flash memory data storage device includes a plurality of memory chips. The host includes a host activity monitoring engine configured to monitor activity of the host and a garbage collection control engine configured to control the background garbage collection performed by the data storage device's garbage collector.

### CROSS REFERENCE TO RELATED APPLICATIONS

This application claims the benefit of U.S. Provisional Application No. 61/167,709, filed Apr. 8, 2009, and titled “DATA STORAGE DEVICE” and U.S. Provisional Application No. 61/187,835, filed Jun. 17, 2009, and titled “PARTITIONING AND STRIPING IN A FLASH MEMORY DATA STORAGE DEVICE,” U.S. Provisional Application No. 61/304,469, filed Feb. 14, 2010, and titled “DATA STORAGE DEVICE,” U.S. Provisional Patent Application No. 61/304,468, filed Feb. 14, 2010, and titled “DATA STORAGE DEVICE,” and U.S. Provisional Patent Application No. 61/304,475, filed Feb. 14, 2010, and titled “DATA STORAGE DEVICE,” all of which are hereby incorporated by reference in entirety. Each of the above-referenced applications is hereby incorporated by reference in its entirety.

### TECHNICAL FIELD

This description relates to a data storage device, and, in particular, to host control of background garbage collection in a data storage device.

### BACKGROUND

Data storage devices may be used to store data. A data storage device may be used with a computing device to provide for the data storage needs of the computing device. In certain instances, it may be desirable to store large amounts of data on a data storage device. Also, it may be desirable to execute commands quickly to read data and to write data to the data storage device.

### SUMMARY

In a general aspect, a method of transferring data between a host and a memory device includes monitoring activity of the host, and controlling background garbage collection of memory blocks of the memory device in response to the monitored activity.

Implementations include one or more of the following features. For example, the memory device can include flash memory chips. Monitoring the activity of the host can include monitoring a usage level of a processor of the host, and the method can further include determining that the usage level exceeds a predetermined level, and then controlling background garbage collection of memory blocks of the memory device in response to the monitored activity can include limiting an amount of cycles of a processor of the data storage device, which are devoted to background garbage collection in response to the determination that the usage level exceeds the predetermined level. Monitoring the activity of the host can include monitoring a rate of reading data from the memory device to the host, and the method can further include determining that the rate of reading data exceeds a predetermined rate, and then controlling background garbage collection of memory blocks of the memory device in response to the monitored activity can include halting the background garbage collection while the rate of reading data exceeds the predetermined level.

Monitoring the activity of the host can include monitoring a rate of reading data from the memory device to the host, and the method further include determining that the rate of reading data exceeds a predetermined rate, and then controlling background garbage collection of memory blocks of the memory device in response to the monitored activity can include limiting an amount of effort devoted to background garbage collection in comparison to an amount of effort devoted to reading data from the memory device to the host while the rate of reading data exceeds the predetermined rate. Monitoring the activity of the host can include receiving a signal that certain read events will occur in which data will be read from the memory device to the host, and then controlling background garbage collection of memory blocks of the memory device in response to the monitored activity can include limiting an amount of effort devoted to background garbage collection in comparison to an amount of effort devoted to reading data from the memory device to the host in response to receipt of the signal.

Controlling background garbage collection of memory blocks of the memory device in response to the monitored activity can include monitoring, from a host device, write operations performed on a block of memory blocks of the memory device, sending instructions from the host device to the memory device to perform background garbage collection on targeted memory blocks of the memory device, limiting, at the host, background garbage collection below a threshold amount, and then, at a later time, allowing background garbage collection above the threshold amount. Controlling background garbage collection of memory blocks of the memory device in response to the monitored activity can include sending a signal from the host to the memory device to instruct a garbage collector of the memory device to limit background garbage collection below a threshold amount, and then, at a later time, sending a signal from the host to the memory device to instruct a garbage collector of the memory device that the limitation on background garbage collection has been ended.

The method can further include determining that certain high priority read events are anticipated to occur, and wherein the signal to instruct a garbage collector of the memory device to limit background garbage collection below a threshold amount can be based on the determination. A query can be received for one or more documents, and the monitored activity can include retrieving data from the memory device in response to the query, and controlling background garbage collection of memory blocks of the memory device in response to the monitored activity to instruct a garbage collector of the memory device to limit background garbage collection below a threshold amount blocking the background garbage collection while the data is retrieved from the memory device.

In another general aspect, an apparatus includes a flash memory data storage device and a host operably coupled to the data storage device via an interface. The flash memory data storage device includes a plurality of memory chips. The host includes a host activity monitoring engine configured to monitor activity of the host and a garbage collection control engine configured to control the background garbage collection performed by the data storage device's garbage collector.

Implementations include one or more of the following features. For example, monitoring the activity of the host can include monitoring a usage level of a processor of the host, and the host activity monitoring engine can be further configured to determine that the usage level exceeds a predetermined level, and controlling background garbage collection of memory blocks of the memory device in response to the monitored activity can include limiting an amount of cycles of a processor of the data storage device, which are devoted to background garbage collection in response to the determination that the usage level exceeds the predetermined level.

Monitoring the activity of the host can include monitoring a rate of reading data from the memory device to the host and determining that the rate of reading data exceeds a predetermined rate, and controlling background garbage collection of memory blocks of the memory device in response to the monitored activity can include halting the background garbage collection while the rate of reading data exceeds the predetermined level. Monitoring the activity of the host can include monitoring a rate of reading data from the memory device to the host and determining that the rate of reading data exceeds a predetermined rate, and controlling background garbage collection of memory blocks of the memory device in response to the monitored activity can include limiting an amount of effort devoted to background garbage collection in comparison to an amount of effort devoted to reading data from the memory device to the host while the rate of reading data exceeds the predetermined rate.

Monitoring the activity of the host can include receiving a signal that certain read events will occur in which data will be read from the memory device to the host, and controlling background garbage collection of memory blocks of the memory device in response to the monitored activity can include limiting an amount of effort devoted to background garbage collection in comparison to an amount of effort devoted to reading data from the memory device to the host in response to receipt of the signal. Controlling background garbage collection of memory blocks of the memory device in response to the monitored activity can include monitoring, from a host device, write operations performed on a block of memory blocks of the memory device, sending instructions from the host device to the memory device to initiate background garbage collection on targeted memory blocks of the memory device, limiting, at the host, background garbage collection below a threshold amount, and then, at a later time, allowing background garbage collection above the threshold amount.

The host can further include a processor configured to determine that certain high priority read events are anticipated to occur, and the limitation of background garbage collection below the threshold amount can be based on the determination. The host can further include a query handler adapted to receive a query for one or more documents, and the monitored activity can include retrieving data from the memory device in response to the query, and controlling background garbage collection of memory blocks of the memory device in response to the monitored activity can include blocking the background garbage collection while the data is retrieved from the memory device.

The memory device can include a plurality of memory chips. Controlling the background garbage collection can include differentially controlling the amount of background garbage collection on different ones of the plurality of memory chips.

In another general aspect, an apparatus includes a flash memory data storage device and a host operably coupled to the data storage device via an interface. The flash memory data storage device includes a plurality of memory chips and a garbage collector configured to perform background garbage collection of memory blocks of the memory device. The host includes a host activity monitoring engine configured to monitor activity of the host and a garbage collection control engine configured to control the background garbage collection performed by the data storage device's garbage collector.

Implementations include one or more of the following features. For example, monitoring the activity of the host can include monitoring a usage level of a processor of the host, where the host activity monitoring engine being further configured to determine that the usage level exceeds a predetermined level, and controlling background garbage collection of memory blocks of the memory device in response to the monitored activity can include limiting an amount of cycles of a processor of the data storage device, which are devoted to background garbage collection in response to the determination that the usage level exceeds the predetermined level. Monitoring the activity of the host can include monitoring a rate of reading data from the memory device to the host and determining that the rate of reading data exceeds a predetermined rate, and controlling background garbage collection of memory blocks of the memory device in response to the monitored activity can include halting the background garbage collection while the rate of reading data exceeds the predetermined level.

Monitoring the activity of the host can include monitoring a rate of reading data from the memory device to the host and determining that the rate of reading data exceeds a predetermined rate, and controlling background garbage collection of memory blocks of the memory device in response to the monitored activity can include limiting an amount of effort devoted to background garbage collection in comparison to an amount of effort devoted to reading data from the memory device to the host while the rate of reading data exceeds the predetermined rate. Monitoring the activity of the host can include receiving a signal that certain read events will occur in which data will be read from the memory device to the host, and controlling background garbage collection of memory blocks of the memory device in response to the monitored activity can include limiting an amount of effort devoted to background garbage collection in comparison to an amount of effort devoted to reading data from the memory device to the host in response to receipt of the signal.

Controlling background garbage collection of memory blocks of the memory device in response to the monitored activity can include sending a signal from the host to the memory device to instruct a garbage collector of the memory device to limit background garbage collection below a threshold amount, and then, at a later time, sending a signal from the host to the memory device to instruct a garbage collector of the memory device that the limitation on background garbage collection has been ended. The host can include a processor configured to determine that certain high priority read events are anticipated to occur, and the signal can be based on the determination.

The host can further include a query handler adapted to receive a query for one or more documents, and the monitored activity can include retrieving data from the memory device in response to the query, and controlling background garbage collection of memory blocks of the memory device in response to the monitored activity can include blocking the background garbage collection while the data is retrieved from the memory device.

The memory device can include a plurality of memory chips. Controlling the background garbage collection performed by the data storage device's garbage collector can include differentially controlling the amount of background garbage collection on different ones of the plurality of memory chips performed by the data storage device's garbage collector. Controlling the background garbage collection performed by the data storage device's garbage collector can include differentially controlling the amount of background garbage collection on different ones of the plurality of memory chips performed by the data storage device's garbage collector.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a data storage device.

FIG. 2 is an exemplary block diagram of a FPGA controller that can be used in the data storage device of FIG. 1.

FIG. 3 is an exemplary block diagram of exemplary computing devices for use with the data storage device of FIG. 1.

FIG. 4 is an exemplary flowchart illustrating an example process of partitioning the data storage device of FIG. 1.

### DETAILED DESCRIPTION

This document describes an apparatus, system(s) and techniques for data storage. Such a data storage apparatus may include a controller board having a controller that may be used with one or more different memory boards, with each of the memory boards having multiple flash memory chips. The data storage apparatus may communicate with a host using an interface on the controller board. In this manner, the controller on the controller board may be configured to receive commands from the host using the interface and to execute those commands using the flash memory chips on the memory boards.

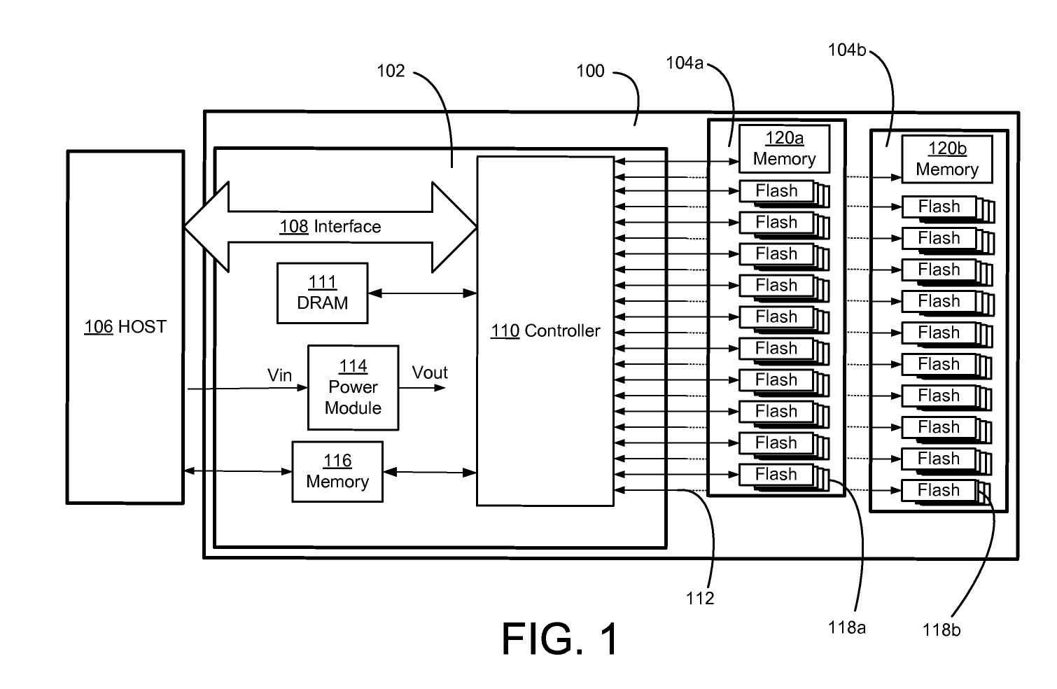

FIG. 1 is a block diagram of a data storage device 100. The data storage device 100 may include a controller board 102 and one or more memory boards 104a and 104b. The data storage device 100 may communicate with a host 106 over an interface 108. The interface 108 may be between the host 106 and the controller board 102. The controller board 102 may include a controller 110, a DRAM 111, multiple channels 112, a power module 114, and a memory module 116. The memory boards 104a and 104b may include multiple flash memory chips 118a and 118b on each of the memory boards. The memory boards 104a and 104b also may include a memory device 120a and 120b.

In general, the data storage device 100 may be configured to store data on the flash memory chips 118a and 118b. The host 106 may write data to and read data from the flash memory chips 118a and 118b, as well as cause other operations to be performed with respect to the flash memory chips 118a and 118b. The reading and writing of data between the host 106 and the flash memory chips 118a and 118b, as well as the other operations, may be processed through and controlled by the controller 110 on the controller board 102. The controller 110 may receive commands from the host 106 and cause those commands to be executed using the flash memory chips 118a and 118b on the memory boards 104a and 104b. The communication between the host 106 and the controller 110 may be through the interface 108. The controller 110 may communicate with the flash memory chips 118a and 118b using the channels 112.

The controller board 102 may include DRAM 111. The DRAM 111 may be operably coupled to the controller 110 and may be used to store information. For example, the DRAM 111 may be used to store logical address to physical address maps and bad block information. The DRAM 111 also may be configured to function as a buffer between the host 106 and the flash memory chips 118a and 118b.

In one exemplary implementation, the controller board 102 and each of the memory boards 104a and 104b are physically separate printed circuit boards (PCBs). The memory board 104a may be on one PCB that is operably connected to the controller board 102 PCB. For example, the memory board 104a may be physically and/or electrically connected to the controller board 102. Similarly, the memory board 104b may be a separate PCB from the memory board 104a and may be operably connected to the controller board 102 PCB. For example, the memory board 104b may be physically and/or electrically connected to the controller board 102.

The memory boards 104a and 104b each may be separately disconnected and removable from the controller board 102. For example, the memory board 104a may be disconnected from the controller board 102 and replaced with another memory board (not shown), where the other memory board is operably connected to controller board 102. In this example, either or both of the memory boards 104a and 104b may be swapped out with other memory boards such that the other memory boards may operate with the same controller board 102 and controller 110.

In one exemplary implementation, the controller board 102 and each of the memory boards 104a and 104b may be physically connected in a disk drive form factor. The disk drive form factor may include different sizes such as, for example, a 3.5″ disk drive form factor and a 2.5″ disk drive form factor.

In one exemplary implementation, the controller board 102 and each of the memory boards 104a and 104b may be electrically connected using a high density ball grid array (BGA) connector. Other variants of BGA connectors may be used including, for example, a fine ball grid array (FBGA) connector, an ultra fine ball grid array (UBGA) connector and a micro ball grid array (MBGA) connector. Other types of electrical connection means also may be used.

The interface 108 may include a high speed interface between the controller 110 and the host 106. The high speed interface may enable fast transfers of data between the host 106 and the flash memory chips 118a and 118b. In one exemplary implementation, the high speed interface may include a Peripheral Component Interconnect Express (“PCIe”) interface. For instance, the PCIe interface may be a PCIe x4 interface or a PCIe x8 interface. The PCIe interface 108 may include a PCIe connector cable assembly to the host 106. In this example, the 110 may include an interface controller configured to interface between the host 106 and the interface 108. The interface controller may include a PCIe endpoint controller. Other high speed interfaces, connectors, and connector assemblies also may be used.

In one exemplary implementation, the communication between the controller board 102 and the flash memory chips 118a and 118b on the memory boards 104a and 104b may be arranged and configured into multiple channels 112. Each of the channels 112 may communicate with one or more flash memory chips 118a and 118b. The controller 110 may be configured such that commands received from the host 106 may be executed by the controller 110 using each of the channels 112 simultaneously or at least substantially simultaneously. In this manner, multiple commands may be executed simultaneously on different channels 112, which may improve throughput of the data storage device 100.

In the example of FIG. 1, twenty (20) channels 112 are illustrated. The completely solid lines illustrate the ten (10) channels between the controller 110 and the flash memory chips 118a on the memory board 104a. The mixed solid and dashed lines illustrate the ten (10) channels between the controller 110 and the flash memory chips 118b on the memory board 104b. As illustrated in FIG. 1, each of the channels 112 may support multiple flash memory chips. For instance, each of the channels 112 may support up to 32 flash memory chips. In one exemplary implementation, each of the 20 channels may be configured to support and communicate with 6 flash memory chips. In this example, each of the memory boards 104a and 104b would include 60 flash memory chips each. Depending on the type and the number of the flash memory chips 118a and 118b, the data storage 100 device may be configured to store up to and including multiple terabytes of data.

The controller 110 may include a microcontroller, a FPGA controller, other types of controllers, or combinations of these controllers. In one exemplary implementation, the controller 110 is a microcontroller. The microcontroller may be implemented in hardware, software, or a combination of hardware and software. For example, the microcontroller may be loaded with a computer program product from memory (e.g., memory module 116) including instructions that, when executed, may cause the microcontroller to perform in a certain manner. The microcontroller may be configured to receive commands from the host 106 using the interface 108 and to execute the commands. For instance, the commands may include commands to read, write, copy and erase blocks of data using the flash memory chips 118a and 118b, as well as other commands.

In another exemplary implementation, the controller 110 is a FPGA controller. The FPGA controller may be implemented in hardware, software, or a combination of hardware and software. For example, the FPGA controller may be loaded with firmware from memory (e.g., memory module 116) including instructions that, when executed, may cause the FPGA controller to perform in a certain manner. The FPGA controller may be configured to receive commands from the host 106 using the interface 108 and to execute the commands. For instance, the commands may include commands to read, write, copy and erase blocks of data using the flash memory chips 118a and 118b, as well as other commands.

The memory module 116 may be configured to store data, which may be loaded to the controller 110. For instance, the memory module 116 may be configured to store one or more images for the FPGA controller, where the images include firmware for use by the FPGA controller. The memory module 116 may interface with the host 106 to communicate with the host 106. The memory module 116 may interface directly with the host 106 and/or may interface indirectly with the host 106 through the controller 110. For example, the host 106 may communicate one or more images of firmware to the memory module 116 for storage. In one exemplary implementation, the memory module 116 includes an electrically erasable programmable read-only memory (EEPROM). The memory module 116 also may include other types of memory modules.

The memory boards 104a and 104b may be configured to operate with different types of flash memory chips 118a and 118b. In one exemplary implementation, the flash memory chips 118a and the flash memory chips 118b may be the same type of flash memory chips including requiring the same voltage from the power module 114 and being from the same flash memory chip vendor. The terms vendor and manufacturer are used interchangeably throughout this document.

In another exemplary implementation, the flash memory chips 118a on the memory board 104a may be a different type of flash memory chip from the flash memory chips 118b on the memory board 104b. For example, the memory board 104a may include SLC NAND flash memory chips and the memory board 104b may include MLC NAND flash memory chips. In another example, the memory board 104a may include flash memory chips from one flash memory chip manufacturer and the memory board 104b may include flash memory chips from a different flash memory chip manufacturer. The flexibility to have all the same type of flash memory chips or to have different types of flash memory chips enables the data storage device 100 to be tailored to different applications being used by the host 106.

In another exemplary implementation, the memory boards 104a and 104b may include different types of flash memory chips on the same memory board. For example, the memory board 104a may include both SLC NAND chips and MLC NAND chips on the same PCB. Similarly, the memory board 104b may include both SLC NAND chips and MLC NAND chips. In this manner, the data storage device 100 may be advantageously tailored to meet the specifications of the host 106.

In another exemplary implementation, the memory board 104a and 104b may include other types of memory devices, including non-flash memory chips. For instance, the memory boards 104a and 104b may include random access memory (RAM) such as, for instance, dynamic RAM (DRAM) and static RAM (SRAM) as well as other types of RAM and other types of memory devices. In one exemplary implementation, both of the memory boards 104a and 104b may include RAM. In another exemplary implementation, one of the memory boards may include RAM and the other memory board may include flash memory chips. Also, one of the memory boards may include both RAM and flash memory chips.

The memory modules 120a and 120b on the memory boards 104a and 104b may be used to store information related to the flash memory chips 118a and 118b, respectively. In one exemplary implementation, the memory modules 120a and 120b may store device characteristics of the flash memory chips. The device characteristics may include whether the chips are SLC chips or MLC chips, whether the chips are NAND or NOR chips, a number of chip selects, a number of blocks, a number of pages per block, a number of bytes per page and a speed of the chips.

In one exemplary implementation, the memory modules 120a and 120b may include serial EEPROMs. The EEPROMs may store the device characteristics. The device characteristics may be compiled once for any given type of flash memory chip and the appropriate EEPROM image may be generated with the device characteristics. When the memory boards 104a and 104b are operably connected to the controller board 102, then the device characteristics may be read from the EEPROMs such that the controller 110 may automatically recognize the types of flash memory chips 118a and 118b that the controller 110 is controlling. Additionally, the device characteristics may be used to configure the controller 110 to the appropriate parameters for the specific type or types of flash memory chips 118a and 118b.

In an example embodiment, the data storage device 100 may be used to store large amounts of data (e.g., many Gigabytes or Terabytes of data) that must be read quickly from the data storage device 100 and supplied to the host 106. For example, the data storage device 100 can be used to cache large volumes of publicly accessible information (e.g., a large corpus of web pages from the World Wide Web, a large library of electronic versions of books, or digital information representing a large volume of telecommunications, etc.) that can be fetched by the host in response to a query. In another example, the data storage device 100 can be used to store an index of publically accessible documents, where the index can be used to locate the documents in response to a query. Thus, it can be important that the relevant data be accessed and returned very quickly in response to a read command issued by the host. However, the information stored in the data storage device also may need to be constantly updated to keep the information up to date as the relevant information changes. For example, if the information on the storage device relates to a corpus of web pages, the information stored on the storage device may need to be updated as the web pages change and as new web pages are created.

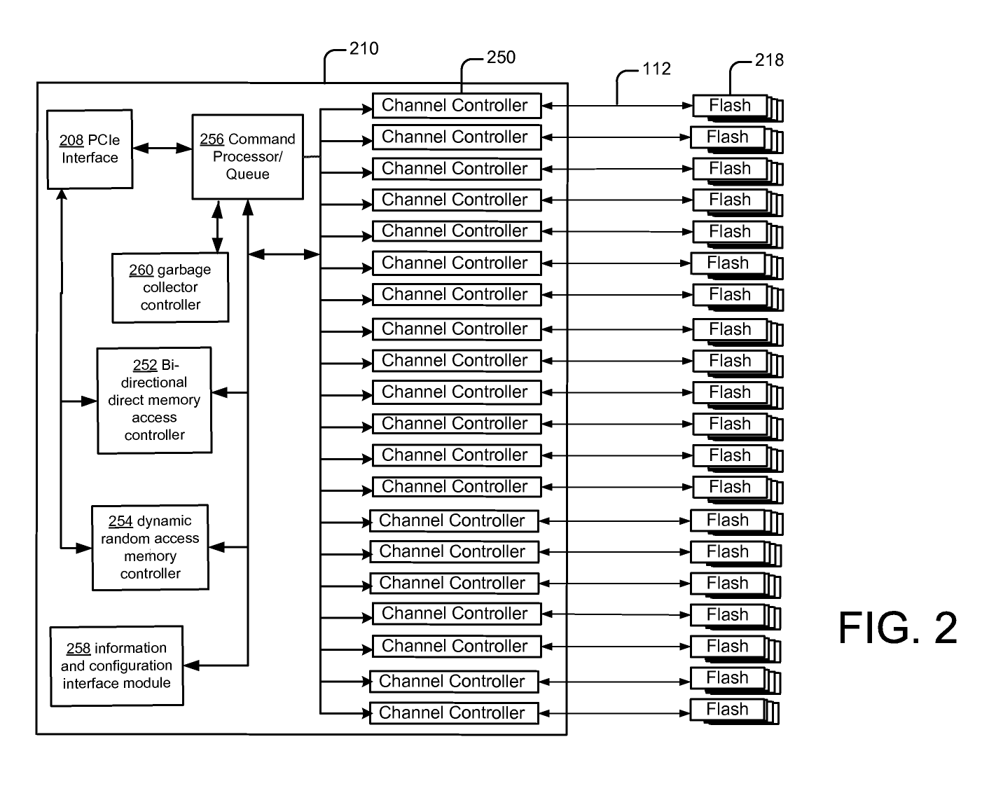

As discussed above, the controller 110 may include a FPGA controller. Referring to FIG. 2, an exemplary block diagram of a FPGA controller 210 is illustrated. The FPGA controller may be configured to operate in the manner described above with respect to controller 110 of FIG. 1. The FPGA controller 210 may include multiple channel controllers 250 to connect the multiple channels 112 to the flash memory chips 218. The flash memory chips 218 are illustrated as multiple flash memory chips that connect to each of the channel controllers 250. The flash memory chips 218 are representative of the flash memory chips 118a and 118b of FIG. 1, which are on the separate memory boards 104a and 104b of FIG. 1. The separate memory boards are not shown in the example of FIG. 2. The FPGA controller 210 may include a PCIe interface module 208, a bi-directional direct memory access (DMA) controller 252, a dynamic random access memory (DRAM) controller 254, a command processor/queue 256, an information and configuration interface module 258, and a garbage collector controller 260.

Information may be communicated with a host (e.g., host 106 of FIG. 1) using an interface. In the example shown in FIG. 2, the FPGA controller 210 includes a PCIe interface to communicate with the host and a PCIe interface module 208. The PCIe interface module 208 may be arranged and configured to receive commands from the host and to send commands to the host. The PCIe interface module 208 may provide data flow control between the host and the data storage device. The PCIe interface module 208 may enable high speed transfers of data between the host and the controller 210 and ultimately the flash memory chips 218. In one exemplary implementation, the PCIe interface and the PCIe interface module 208 may include a 64-bit bus. The bi-directional direct memory access (DMA) controller 252 may be arranged and configured to control the operation of the bus between the PCIe interface module 208 and the command processor/queue 256.

The bi-directional DMA controller 252 may be configured to interface with the PCIe interface 208, and each of the channel controllers 250. The bi-directional DMA controller 252 enables bi-directional direct memory access between the host 106 and the flash memory chips 218.

The DRAM controller 254 may be arranged and configured to control the translation of logical to physical addresses. For example, in an implementation in which the host addresses the memory space using logical addresses, the DRAM controller 254 may assist the command processor/queue 256 with the translation of the logical addresses used by the host to the actual physical addresses in the flash memory chips 218 related to data being written to or read from the flash memory chips 218. A logical address received from the host may be translated to a physical address for a location in one of the flash memory chips 218. Similarly, a physical address for a location in one of the flash memory chips 218 may be translated to a logical address and communicated to the host.

The command processor/queue 256 may be arranged and configured to receive the commands from the host through the PCIe interface module 208 and to control the execution of the commands through the channel controllers 250. The command processor/queue 256 may maintain a queue for a number of commands to be executed and order the commands using an ordered list to ensure that the oldest commands may be processed first. The command processor 100 may maintain the order of the commands designated for the same flash memory chip and may reorder the commands designated for different flash memory chips. In this manner, multiple commands may be executed simultaneously and each of the channels 112 may be used simultaneously or at least substantially simultaneously.

The command processor/queue 256 may be configured to process commands for different channels 112 out of order and preserve per-channel command ordering. For instance, commands that are received from the host and that are designated for different channels may be processed out of order by the command processor/queue 256. In this manner, the channels may be kept busy. Commands that are received from the host for processing on the same channel may be processed in the order that the commands were received from the host by the command processor/queue 256. In one exemplary implementation, the command processor/queue 256 may be configured to maintain a list of commands received from the host in an oldest-first sorted list to ensure timely execution of the commands.

The channel controllers 250 may be arranged and configured to process commands from the command processor/queue 256. Each of the channel controllers 250 may be configured to process commands for multiple flash memory chips 218. In one exemplary implementation, each of the channel controllers 250 may be configured to process commands for up to and including 32 flash memory chips 218.

The channel controllers 250 may be configured to process the commands from the command processor/queue 256 in order as designated by the command processor/queue 256. Examples of the commands that may be processed include, but are not limited to, reading a flash page, programming a flash page, copying a flash page, erasing a flash block, reading a flash block's metadata, mapping a flash memory chip's bad blocks, and resetting a flash memory chip.

The information and configuration interface module 258 may be arranged and configured to interface with a memory module (e.g., memory module 116 of FIG. 1) to receive configuration information for the FPGA controller 210. For example, the information and configuration interface module 258 may receive one or more images from the memory module to provide firmware to the FPGA controller 210. Modifications to the images and to the firmware may be provided by the host to the controller 210 through the information and configuration interface module 258. Modifications received through the information and configuration interface module 258 may be applied to any of the components of the controller 210 including, for example, the PCIe interface module 208, the bi-directional direct memory access (DMA) controller 252, the DRAM controller 254, the command processor/queue 256 and the channel controllers 250. The information and configuration interface module 258 may include one or more registers, which may be modified as necessary by instructions from the host.

The FPGA controller 210 may be arranged and configured to cooperate and process commands in conjunction with the host. The FPGA controller 210 may perform or at least assist in performing error correction, bad block management, logical to physical mapping, garbage collection, wear levelling, partitioning and low level formatting related to the flash memory chips 218.

The garbage collection controller 260 of the FPGA controller 210 can be used to coordinate and control garbage collection operations on the data storage device 100. As discussed above, cells of memory chips 218 are organized in block units and each block includes a plurality of pages. Data can be written to and read from a memory chip 218 in page-sized units, but when data is erased from a memory chip 218 is be erased in block-sized units. In addition, flash memory chips 218 cannot be updated in-place—that is, data written to a page of a chip cannot be overwritten by new data. Instead, the new data must be written to a different location, and the old data must be declared invalid. Because of these constraints, when updating of data on the data storage device an out-of-place updating scheme must be used in which the new data are written to a different physical location than the old data, and then the old data are declared invalid.

Thus, pages of flash memory chips 218 can have one of three states: (1) free (wherein the page contains no data and is available to store new or updated data; (2) valid (wherein the page contains new or recently updated data that is available to be read); or (3) invalid (wherein the page contains obsolete data or data marked for deletion). As one can imagine, after some cycles of updating data on a flash memory chip 218 using the out-of-place updating procedure, many blocks will have both valid and invalid pages, which reduces the number of free pages available to receive new or updated data.

Therefore, a garbage collection process is used to reclaim free pages on a memory chip. In a garbage collection process, a block is targeted for having all of its data erased, so that the pages of the block can be reclaimed as free pages. Before erasing the pages of the block, the valid pages of the block are copied to a new location into free pages of one or more different blocks or one or more different chips 218. After all the valid pages of the targeted block are successfully copied to the new locations, the pages of the targeted block are erased, so that they are free to have data written to them.

Garbage collection is important for using a flash memory device, but garbage collection is also time-consuming. This is because in a flash memory storage device, write operations to a flash memory chip take much longer (e.g., approximately 10 times longer) than read operations from a flash memory chip, and because erase operations take much longer (e.g., approximately 10 times longer) than write operations operations. Thus, the interleaving garbage collection operations with the read operations associated with reading a file from the data storage device 100 to the host 106 can significantly delay the reading of the data file from the data storage device to the host.

Garbage collection can be performed when it is necessary to reclaim free space on a memory chip in order to write new or updated data to the chip. For example, if the chip contains fewer free pages than are necessary to receive the data that is intended to be written to the chip, then garbage collection must be performed to erase enough blocks to reclaim a sufficient number of pages to receive the data to be written to the chip.

Alternatively, garbage collection can be performed in background operations to periodically erase blocks and to maintain the number of invalid pages at a relatively low amount, so that a sufficient number of free pages exist to receive data to be written to the memory chip 218. Thus, the garbage collector controller 260 can monitor the read and/or write operations that are being performed on a block of a memory chip 218, and perform garbage collection in view of the monitored activity. For example, if such operations are not being performed, the garbage collector controller 260 can instruct the command processor/queue 256 to initiate a garbage collection process on a targeted block, which might be targeted based on the number of invalid pages on the block. In another example, the rate of read and/or write operations can be monitored by the garbage collector controller 260, and if the rate of read and/or write operations is below a threshold value the garbage collector controller 260 can instruct the command processor/queue 256 to initiate a garbage collection process on a targeted block. In addition to monitoring the read or write operations at the per memory block level, the garbage collector 260 also may monitor read or write operations on a per memory chip level or a per channel level, and can perform background garbage collection in view of the monitored operations.

However, because garbage collection is so time-consuming compared to read operations and even compared to write operations, and because read and write performance are important performance metrics for the data storage device 100, background garbage collection can be suppressed or limited by the host 106 at certain times to improve the read and/or write performance of the data storage device 100.

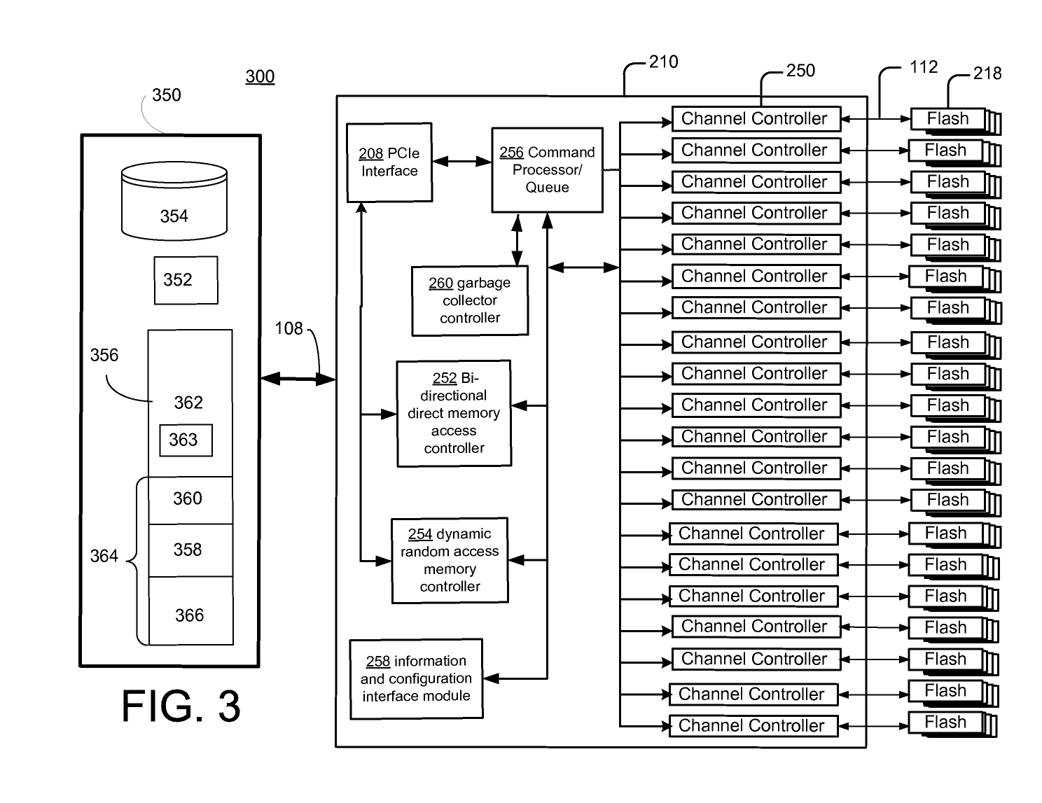

FIG. 3 is a schematic block diagram of a data storage apparatus 300 that includes a host 350 and the data storage device 210. As described above, the data storage device 210 can be connected to the host 350 though an interface 308, which can be a high speed interface, such as, for example a PCIe interface. The host can include, for example, a processor 352, a first memory 354, a second memory 356, and a host activity monitoring engine 360. The first memory 354 can include, for example, a non-volatile memory device (e.g., a hard disk) adapted for storing machine-readable, executable code instructions that can be executed by the processor 352. The code instructions stored on the first memory 354 can be loaded into the second memory (e.g., a volatile memory, such as, a random access memory) 356 where they can be executed by the processor 352 to create the garbage collection control engine 358 and the host activity monitoring engine 360. The second memory can include logical blocks of “user space” 362 devoted to user mode applications and logical blocks of “kernel space” 364 devoted to running the lower-level resources that user-level applications must control to perform their functions. The garbage collection control engine 358 and the host activity monitoring engine 360 can reside in the kernel space 364 of the second memory 356.

The host activity monitoring engine 360 can be configured to monitor activity of the host 106. The garbage collection control engine 358 can be configured to control the background garbage collection performed by the data storage device's background garbage collector 260. For example, in one implementation, the host activity monitoring engine 360 can determine a usage level of a processor (e.g., processor 352) of the host 106, where, in one implementation, the processor may be involved in the transfer of data between the host 106 and the data storage device 210. For example, the usage level may include a percentage of a predefined capacity at which the processor operates or a rate at which the processor executes operations. The determined usage level can be compared to a predetermined usage level. When the usage level exceeds the predetermined usage level, the garbage collection control engine 358 can limit an amount of cycles of a processor (e.g., a processor that executes the read, write, copy, and erase operations) of the data storage device 210, which are devoted to background garbage collection in response to the determination that the usage level exceeds the predetermined level. The garbage collection control engine 358 may provide this limit by sending a signal to the data storage device's background garbage collector 260 instructing it to halt background garbage collection to limit background garbage collection below the threshold amount so as not to exceed the predetermined level.

In another implementation, the host activity monitoring engine 360 can monitor a rate at which data is read from the memory device 210 to the host 106. The monitoring engine can further determine if the rate of reading data exceeds a predetermined rate. If so, then the garbage collection control engine 358 can control background garbage collection of memory blocks of the memory device 210 in response to the monitored activity by halting the background garbage collection while the rate of reading data exceeds the predetermined level. In this manner, background garbage collection can be suppressed during bursts of reading data from the data storage device 210 to the host 350.

In another implementation, the garbage collection control engine 358 can pro-actively control background garbage collection on the data storage device 210. For example, the host may know that a number of important read events will be occurring soon, which should not be interrupted by background garbage collection on the data storage device. In such a case, host activity monitoring engine 360 may receive a signal (e.g., from the processor 352 that may be executing an application layer program that resides in the user space portion 362 of the memory 364) that certain read events will occur in which data will be read from the memory device 210 to the host 350. Then, the host activity monitoring engine 360 can inform the garbage collection control engine 358 of the anticipated read events. In response, the garbage collection control engine 358 can control background garbage collection of memory blocks of the memory device by limiting an amount of effort devoted to background garbage collection in comparison to an amount of effort devoted to reading data from the memory device to the host in response to receipt of the signal. Again, the garbage collection control engine 358 may provide this limit by sending a signal to the data storage device's background garbage collector 260 instructing it to halt background garbage collection to limit background garbage collection below the threshold amount. For example, an amount of garbage collection or erase events may be limited below a certain percentage of read and/or write events. After the identified important read events have occurred then the limitation on background garbage collection can be lifted. For example, the host may send a signal to instruct the garbage collector 260 of the memory device 210 that the limitation on background garbage collection has been ended.

In one implementation, the host can include a query handler 363 operating in user space 362 that is configured to receive a query for one or more documents that reside on the data storage device 302. Then, while one or more of the documents are being retrieved from the data storage device 210 to the host 350, the garbage collection control engine 358 can block background garbage collection that occurs on the data storage device until the documents have been retrieved.

As described above, the memory device 210 can include a plurality of memory chips 218 and a plurality of channels 112, each of which is operable connected to a plurality of memory chips. The garbage collector 260 can be configured to perform, at different times, garbage collection on blocks of specific memory chips but not on blocks of other memory chips, or on blocks of memory chips 218 connected to specific channels 112 but not on blocks of memory chips 218 connected to other channels 112. Because of this, the garbage collection control engine 358 be configured to control the background garbage collection performed by the data storage device's garbage collector 260 by differentially controlling the amount of background garbage collection on different ones of the plurality of memory chips 218 or by differentially controlling the amount of background garbage collection on chips connected to different ones of the plurality of channels 112. That, is the background garbage collection can be limited on certain chips or channels that are experiencing, or that are expected to experience, high rates of read events, while unlimited background garbage collection is allowed to proceed on other chips or chips connected to other channels.

In another implementation, garbage collection, rather than being performed by a garbage collector 260 residing on the controller 210, can be controlled and performed from the host 350. For example, the garbage collection control engine 358, in addition to limiting the amount of processor cycles that are devoted to background garbage collection in response to a determination that a usage level exceeds a predetermined level, also can perform the garbage collection functions that are described above as being performed, in a particular implementation, by the garbage collector 260. Thus, the garbage collection control engine 358 on the host 350 can monitor the read and/or write operations that are being performed on a block of a memory chip 218, and can perform garbage collection in view of the monitored activity. For example, if such operations are not being performed, the garbage collection control engine 358 can instruct the command processor/queue 256 of the controller 210 to initiate a garbage collection process on a targeted block, which might be targeted based on the number of invalid pages on the block. In another example, the rate of read and/or write operations can be monitored by the garbage collection control engine 358, and if the rate of read and/or write operations is below a threshold value the garbage collection control engine 358 can instruct the command processor/queue 256 to initiate a garbage collection process on a targeted block. In addition to monitoring the read or write operations at the per memory block level, the garbage collection control engine 358 also can monitor read or write operations on a per memory chip level or a per channel level, and can perform background garbage collection in view of the monitored operations.

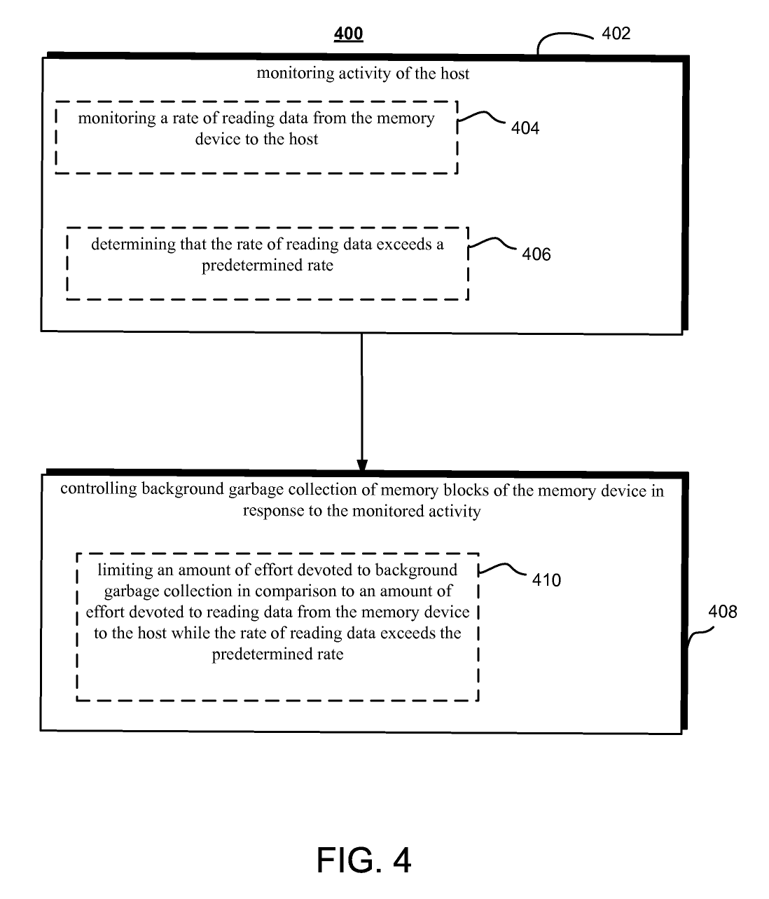

FIG. 4 is an exemplary flowchart illustrating an example process 400 of reading data from a data storage device to a host. Activity on the host can be monitored (402). For example, a rate at which data is read from the memory device to the host can be monitored (404), and a determination can be made about whether the rate exceeds a predetermined rate (406). Background garbage collection of memory blocks of the memory device can be controlled in response to the monitored activity of the host. For example, an amount of effort devoted to background garbage collection in comparison to an amount of effort devoted to reading data from the memory device to the host can be limited while the rate of reading data exceeds the predetermined rate.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., a FPGA or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of transferring data between a host and a memory device, the method comprising:
monitoring activity of the host; and
controlling background garbage collection of memory blocks of the memory device in response to the monitored activity.

2. The method of claim 1, wherein the memory device comprises flash memory chips.

3. The method of claim 1, wherein monitoring the activity of the host comprises monitoring a usage level of a processor of the host, the method further comprising:
determining that the usage level exceeds a predetermined level, and
wherein controlling background garbage collection of memory blocks of the memory device in response to the monitored activity comprises limiting an amount of cycles of a processor of the data storage device, which are devoted to background garbage collection in response to the determination that the usage level exceeds the predetermined level.

4. The method of claim 1, wherein monitoring the activity of the host comprises monitoring a rate of reading data from the memory device to the host, the method further comprising:
determining that the rate of reading data exceeds a predetermined rate, and
wherein controlling background garbage collection of memory blocks of the memory device in response to the monitored activity comprises halting the background garbage collection while the rate of reading data exceeds the predetermined level.

5. The method of claim 1, wherein monitoring the activity of the host comprises monitoring a rate of reading data from the memory device to the host, the method further comprising:
determining that the rate of reading data exceeds a predetermined rate, and
wherein controlling background garbage collection of memory blocks of the memory device in response to the monitored activity comprises limiting an amount of effort devoted to background garbage collection in comparison to an amount of effort devoted to reading data from the memory device to the host while the rate of reading data exceeds the predetermined rate.

6. The method of claim 1, wherein monitoring the activity of the host comprises receiving a signal that certain read events will occur in which data will be read from the memory device to the host, and
wherein controlling background garbage collection of memory blocks of the memory device in response to the monitored activity comprises limiting an amount of effort devoted to background garbage collection in comparison to an amount of effort devoted to reading data from the memory device to the host in response to receipt of the signal.

7. The method of claim 1, wherein the memory device comprises a plurality of memory chips.

8. The method of claim 1, wherein controlling background garbage collection of memory blocks of the memory device in response to the monitored activity comprises:
monitoring, from a host device, write operations performed on a block of memory blocks of the memory device;
sending instructions from the host device to the memory device to perform background garbage collection on targeted memory blocks of the memory device;
limiting, at the host, background garbage collection below a threshold amount; and then, at a later time,
allowing background garbage collection above the threshold amount.

9. The method of claim 1, wherein controlling background garbage collection of memory blocks of the memory device in response to the monitored activity comprises:
sending a signal from the host to the memory device to instruct a garbage collector of the memory device to limit background garbage collection below a threshold amount; and then, at a later time,
sending a signal from the host to the memory device to instruct a garbage collector of the memory device that the limitation on background garbage collection has been ended.

10. The method of claim 9, further comprising:
determining that certain high priority read events are anticipated to occur, and
wherein the signal is based on the determination.

11. The method of claim 9, further comprising:
receiving a query for one or more documents;
wherein the monitored activity includes retrieving data from the memory device in response to the query; and
wherein controlling background garbage collection of memory blocks of the memory device in response to the monitored activity comprises blocking the background garbage collection while the data is retrieved from the memory device.

12. An apparatus comprising:
a flash memory data storage device including:
a plurality of memory chips;
a host operably coupled to the data storage device via an interface, the host including:
a host activity monitoring engine configured to monitor activity of the host; and
a garbage collection control engine configured to control the background garbage collection performed by the data storage device's garbage collector.

13. The apparatus of claim 12, wherein monitoring the activity of the host comprises monitoring a usage level of a processor of the host, the host activity monitoring engine being further configured to:
determine that the usage level exceeds a predetermined level, and
wherein controlling background garbage collection of memory blocks of the memory device in response to the monitored activity comprises limiting an amount of cycles of a processor of the data storage device, which are devoted to background garbage collection in response to the determination that the usage level exceeds the predetermined level.

14. The apparatus of claim 12, wherein monitoring the activity of the host comprises monitoring a rate of reading data from the memory device to the host and determining that the rate of reading data exceeds a predetermined rate, and
wherein controlling background garbage collection of memory blocks of the memory device in response to the monitored activity comprises halting the background garbage collection while the rate of reading data exceeds the predetermined level.

15. The apparatus of claim 12, wherein monitoring the activity of the host comprises monitoring a rate of reading data from the memory device to the host and determining that the rate of reading data exceeds a predetermined rate, and
wherein controlling background garbage collection of memory blocks of the memory device in response to the monitored activity comprises limiting an amount of effort devoted to background garbage collection in comparison to an amount of effort devoted to reading data from the memory device to the host while the rate of reading data exceeds the predetermined rate.

16. The apparatus of claim 12, wherein monitoring the activity of the host comprises receiving a signal that certain read events will occur in which data will be read from the memory device to the host, and
wherein controlling background garbage collection of memory blocks of the memory device in response to the monitored activity comprises limiting an amount of effort devoted to background garbage collection in comparison to an amount of effort devoted to reading data from the memory device to the host in response to receipt of the signal.

17. The apparatus of claim 12, wherein controlling background garbage collection of memory blocks of the memory device in response to the monitored activity comprises:
monitoring, from a host device, write operations performed on a block of memory blocks of the memory device;
sending instructions from the host device to the memory device to initiate background garbage collection on targeted memory blocks of the memory device;
limiting, at the host, background garbage collection below a threshold amount; and then, at a later time,
allowing background garbage collection above the threshold amount.

18. The apparatus of claim 17,
wherein the host further includes a processor configured to determine that certain high priority read events are anticipated to occur, and
wherein the limitation of background garbage collection below the threshold amount is based on the determination.

19. The apparatus of claim 17,
wherein the host further comprises a query handler adapted to receive a query for one or more documents;
wherein the monitored activity includes retrieving data from the memory device in response to the query; and
wherein controlling background garbage collection of memory blocks of the memory device in response to the monitored activity comprises blocking the background garbage collection while the data is retrieved from the memory device.

20. The apparatus of claim 12, wherein the memory device comprises a plurality of memory chips.

21. The apparatus of claim 20, wherein controlling the background garbage collection includes differentially controlling the amount of background garbage collection on different ones of the plurality of memory chips.

22. An apparatus comprising:
a flash memory data storage device including:
a plurality of memory chips;
a garbage collector configured to perform background garbage collection of memory blocks of the memory device;
a host operably coupled to the data storage device via an interface, the host including:
a host activity monitoring engine configured to monitor activity of the host; and
a garbage collection control engine configured to control the background garbage collection performed by the data storage device's garbage collector.

23. The apparatus of claim 22, wherein monitoring the activity of the host comprises monitoring a usage level of a processor of the host, the host activity monitoring engine being further configured to:
determine that the usage level exceeds a predetermined level, and
wherein controlling background garbage collection of memory blocks of the memory device in response to the monitored activity comprises limiting an amount of cycles of a processor of the data storage device, which are devoted to background garbage collection in response to the determination that the usage level exceeds the predetermined level.

24. The apparatus of claim 22, wherein monitoring the activity of the host comprises monitoring a rate of reading data from the memory device to the host and determining that the rate of reading data exceeds a predetermined rate, and
wherein controlling background garbage collection of memory blocks of the memory device in response to the monitored activity comprises halting the background garbage collection while the rate of reading data exceeds the predetermined level.

25. The apparatus of claim 22, wherein monitoring the activity of the host comprises monitoring a rate of reading data from the memory device to the host and determining that the rate of reading data exceeds a predetermined rate, and
wherein controlling background garbage collection of memory blocks of the memory device in response to the monitored activity comprises limiting an amount of effort devoted to background garbage collection in comparison to an amount of effort devoted to reading data from the memory device to the host while the rate of reading data exceeds the predetermined rate.

26. The apparatus of claim 22, wherein monitoring the activity of the host comprises receiving a signal that certain read events will occur in which data will be read from the memory device to the host, and
wherein controlling background garbage collection of memory blocks of the memory device in response to the monitored activity comprises limiting an amount of effort devoted to background garbage collection in comparison to an amount of effort devoted to reading data from the memory device to the host in response to receipt of the signal.

27. The apparatus of claim 22, wherein controlling background garbage collection of memory blocks of the memory device in response to the monitored activity comprises:
sending a signal from the host to the memory device to instruct a garbage collector of the memory device to limit background garbage collection below a threshold amount; and then, at a later time,
sending a signal from the host to the memory device to instruct a garbage collector of the memory device that the limitation on background garbage collection has been ended.

28. The apparatus of claim 27,
wherein the host further includes a processor configured to determine that certain high priority read events are anticipated to occur, and
wherein the signal is based on the determination.

29. The apparatus of claim 27,
wherein the host further comprises a query handler adapted to receive a query for one or more documents;
wherein the monitored activity includes retrieving data from the memory device in response to the query; and
wherein controlling background garbage collection of memory blocks of the memory device in response to the monitored activity comprises blocking the background garbage collection while the data is retrieved from the memory device.

30. The apparatus of claim 22, wherein the memory device comprises a plurality of memory chips.

31. The apparatus of claim 30, wherein controlling the background garbage collection performed by the data storage device's garbage collector includes differentially controlling the amount of background garbage collection on different ones of the plurality of memory chips performed by the data storage device's garbage collector.
